(19) United States
(12) Patent Application Publication
(10) Pub. No.: US 2011/0055609 A1
(43) Pub. Date: Mar. 3, 2011

(54) Controlling the Power State of a Computer

(76) Inventors: Sumir KARAYI, London (GB); Mark Blackburn, London (GB); Andrew Hawkins, London (GB); Richard Cudd, London (GB); Sophie Chang, London (GB)

(21) Appl. No.: 12/860,956

(22) Filed: Aug. 23, 2010

(30) Foreign Application Priority Data
Sep. 2, 2009 (GB) 0915235.6

(51) Int. Cl. G06F 1/00

(52) U.S. Cl. 713/323; 713/300

(57) ABSTRACT

A computer implemented method of controlling a computer comprises periodically determining the total value of at least one activity metric of the controlled computer. The contribution(s) to the said total value(s) of one or more predetermined activities are determined. In one embodiment, the said contribution(s) are subtracted from the said total value(s) to provide respective net value(s). The net values are compared with respective preset values and the power state of the computer is controlled in dependence on the comparison. The one or more predetermined activities may be identified using a predetermined data set. In another embodiment the net value of at least one activity metric of the monitored computer is a net value excluding contributions to the said value(s) from the said one or more predetermined activities identified from the said data set.

### FIELD OF THE INVENTION

The present invention relates to controlling a computer. The invention relates to a method of controlling a computer, computers and programs for implementing the methods.

### BACKGROUND OF THE INVENTION

Computers consume electrical energy to operate. They consume electrical energy even when they are apparently idle. An idle computer may consume up to 60% of its fully active power consumption. That is wasteful. Large server farms having hundreds or even thousands of servers consume very large amounts of power. The power consumed by a computer is released as heat and server rooms thus require air conditioning equipment which in turn also consume power. It is thus desirable to control the power consumption of computers especially when they are idle. It is known from for example Microsoft Windows (RTM) to provide an idle timer which reduces the power consumption of a computer if for example there has been no input activity for a set period of time.

US-A-2002/0004912 (Fung) discloses power management of computers. Fung discloses several power management schemes including: detection of a predetermined code thread; reduction of power by lowering various clock frequencies or removal of power from system components; while in power saving mode continuing to monitor the occurrence or non-occurrence of a predefined event or activity. Fung also teaches that power management can take place at different OSI levels. For example, power management may occur dependent on:—the number of CPU idle threads within a fixed time period; some statistical evaluation of CPU idleness; handling of TCP/IP packets; or the number of times a specific port address is or has been requested within a fixed time period. These events or activities may be used in combination. Different modes of power saving may be adopted. Fung also discloses a direct transition between a full power mode and an inactive mode.

US-A-2007/0283176 (Tobias et al) discloses power management of a computer to adapt the power level to the performance of the computer. Tobias measures performance using a single utilization index which is the sum of plural Task Utilization values divided by a time T which is the elapsed time between successive measurements of the index. Task Utilization is how much CPU time a task has incurred. The index is compared with high and low thresholds, and power is managed on the basis of the comparisons. Certain tasks, for example tasks below a certain level of priority, may be excluded from the index.

### SUMMARY OF THE INVENTION

In accordance with one aspect of the present invention, there is provided a computer implemented method of controlling a computer comprising: periodically determining, as net values, the values of respective ones of a plurality of activity metrics of the controlled computer excluding the contributions to the said values of respective sets of one or more predetermined activities; comparing the net values with respective threshold values; and controlling the power state of the computer in dependence on the comparisons.

The predetermined activities may be identified in a data set. Determining the value of each activity metric of the computer may comprise summing the contributions of processes running on the monitored computer and network connections active on the monitored computer which are not identified in the data set.

An embodiment of the present invention comprises, in respect of a said activity metric, periodically determining the net value thereof by determining the total values of activity metrics, determining the contributions to the said total values of one or more predetermined activities, and subtracting the said contributions from the said total values to provide the respective net values. The said one or more predetermined activities may be identified by a data set stored in a data store, and the data set is used to determine the contributions of which activities are to be subtracted from the said total value(s).

In one implementation, the computer adopts a predetermined low power state if the net values of none of the metrics exceeds the respective associated threshold values.

The computer may adopt a high power state if any of the said net values exceeds its associated threshold value or in response to a predetermined event occurring.

The predetermined activities may be selected by a user or may be preset by a designer of software implementing the method.

The method may be regarded as allowing the control of a computer based on the net useful work it performs. The inventors' inventive insight is that knowing the main purpose of a computer enables a user or designer to select activities (hereinafter referred to as “non-useful activities”) which do not contribute to that main purpose and use that to provide a measure of net useful work. Non-useful activities as represented by the predetermined activities are subtracted from the total work done by the computer to provide a measure of net useful work or excluded from the calculation of the useful work. What is not useful may be a subjective judgement of the designer or user and depends on their judgement of the function to be carried out by the computer. For example a computer which acts as a server in a network has the main function of serving external clients. Activities such as antivirus and defragmentation which do not directly serve the main purpose may be regarded as non-useful to the main purpose of one server but could be regarded as useful in another server.

In embodiments of the invention, the values of one or more activity metrics are determined periodically. The periodic determination may be regular or irregular. For example the determination may occur in each of a succession of time slots. Alternatively, the periodic determination may take place from time to time in response to an event: for example in response to a logon occurring, a process appearing, or a network connection occurring.
It will be appreciated that embodiments of the invention provide a measuring instrument which measures useful work carried out by a computer.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram of a network of computers, in this example, servers;

FIG. 2 is a schematic diagram of an operating system and programs present on a server of FIG. 1;

FIG. 3 a schematic diagram of an operating system and programs present on an administrator's workstation of FIG. 1;

FIG. 4 is a schematic diagram of the contents of a database of FIG. 1;

FIG. 5 is a flow chart illustrating a method of controlling a computer in accordance with an example of the present invention;

FIG. 6 is a diagram illustrating the calculation of net CPU activity;

FIG. 7 is a diagram illustrating the determining a net number of TCP/IP connections;

FIG. 8 a diagram illustrating the calculation of net I/O activity; and

FIG. 9 is a diagram illustrating the production of a list of excluded activities.

### DETAILED DESCRIPTION OF ILLUSTRATIVE METHODS IN ACCORDANCE WITH THE INVENTION

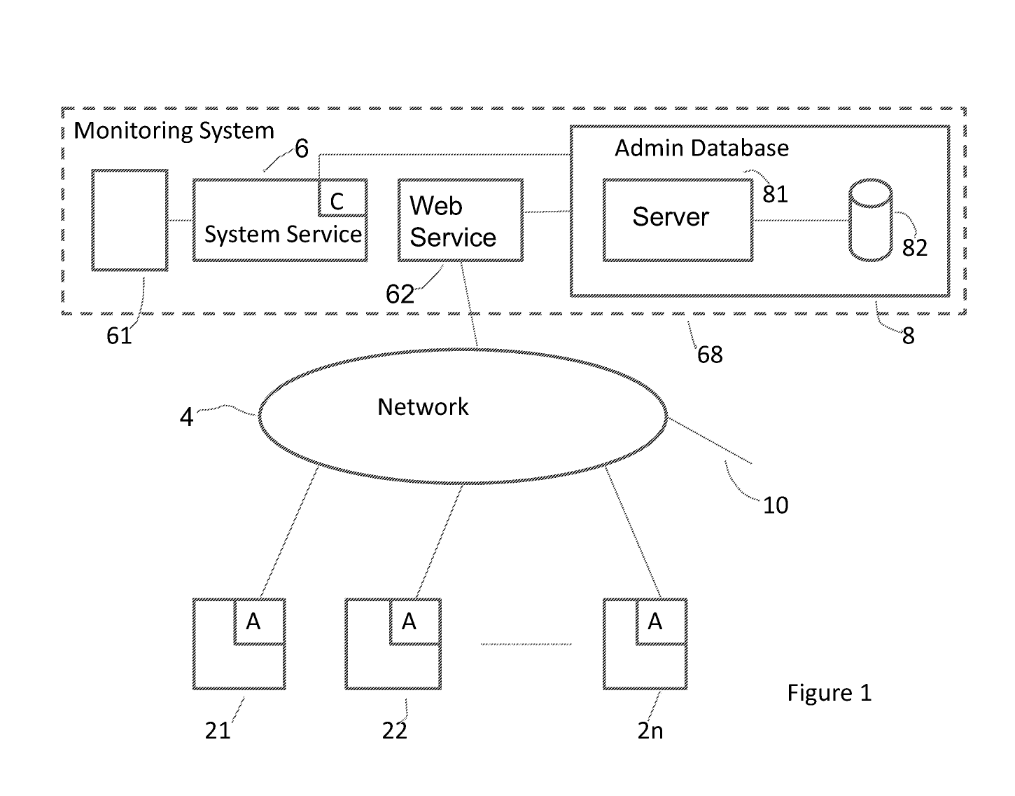

Overview of an example of a system in accordance with the invention: FIGS. 1, 2 and 3.

Referring to FIG. 1, the system comprises servers 21, 22, 2n, an administrator's workstation 6 with a display device 61, a web service 62 running on a computer, and an administrative database 8 connected by a network 4. The administrator's console interacts with the database 8. The webservice interacts with the database and the servers 2n. The servers 21 to 2n may be servers of a large server farm having a large number of servers, for example hundreds or more servers. The database may itself comprise a server 81 having a data storage device 82. The database 8 and the workstation 6 together form a monitoring system 68.

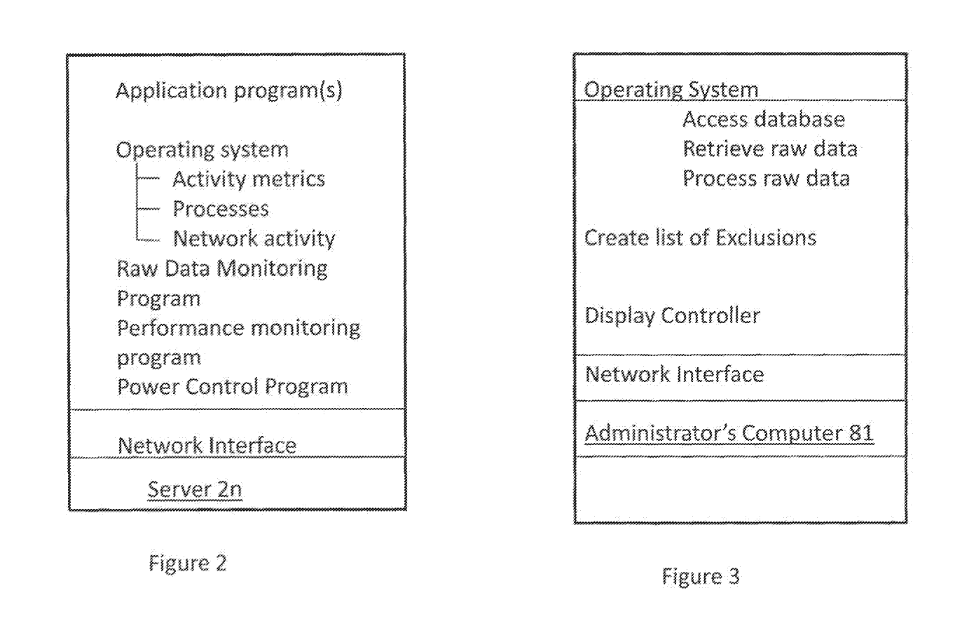

In this example of the invention, as illustrated in FIG. 2, each server 2n has, amongst other programs: an operating system; one or more application programs which define the role of the server; a monitoring program, denoted A in FIG. 1, which monitors activity of the server; and a network interface. The monitoring program interacts with the operating system to obtain the data including information identifying the server and other data, relating to the activities of the computer as described herein below. The monitoring program sends the raw monitored data to the database 8 via the network interface, the network 4 to the webservice 62 which transfers the raw data to the database 8. In this example, the monitoring programs A communicate with the webservice using the http protocol. Each server 2n has a power control program which controls the power state of the server as described herein. The power control program interacts with the operating system to obtain data relating to the activities of the computer. Power control is performed on the basis of settings downloaded by the server 2n from the database. The settings are created by the administrator.

In this example, as indicated in FIG. 3, the administrator's workstation 6 has, amongst other programs, an operating system, a network interface, a display controller, and a program for interfacing with the database.

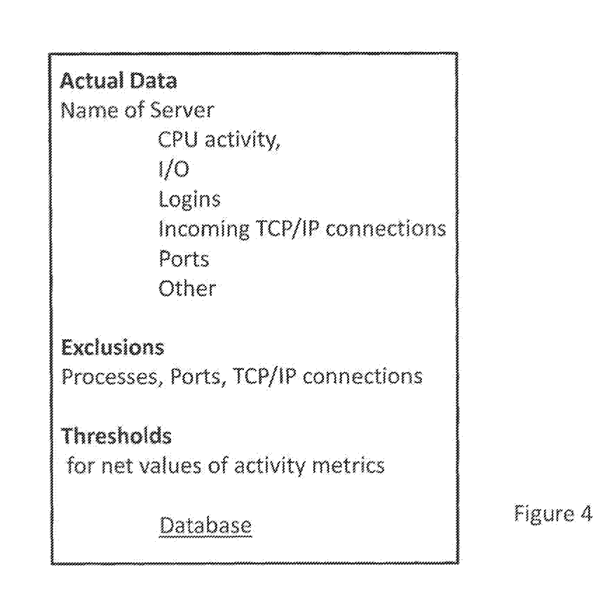

Referring to FIG. 4, the database stores the raw data provided by the monitoring program of a server. In this example the raw data comprises: the name of the server; metrics of CPU activity, I/O, logins, and incoming TCP/IP connections; names of processes; and identification of incoming TCP/IP connections by a combination of port number used and processes associated with the port and the connection. The database may also store source IP addresses of incoming network connections, and other data for example data identifying any connection to a process X, any connection to a port Y or any connection from a source address Z.

The database processes the raw data to store it in an organised way.

The raw data is analysed as discussed below and a data set of excluded processes and a data set of excluded incoming TCP/IP connections identified by a combination of port number and associated process(es) are stored. Also thresholds of activity metrics are stored.

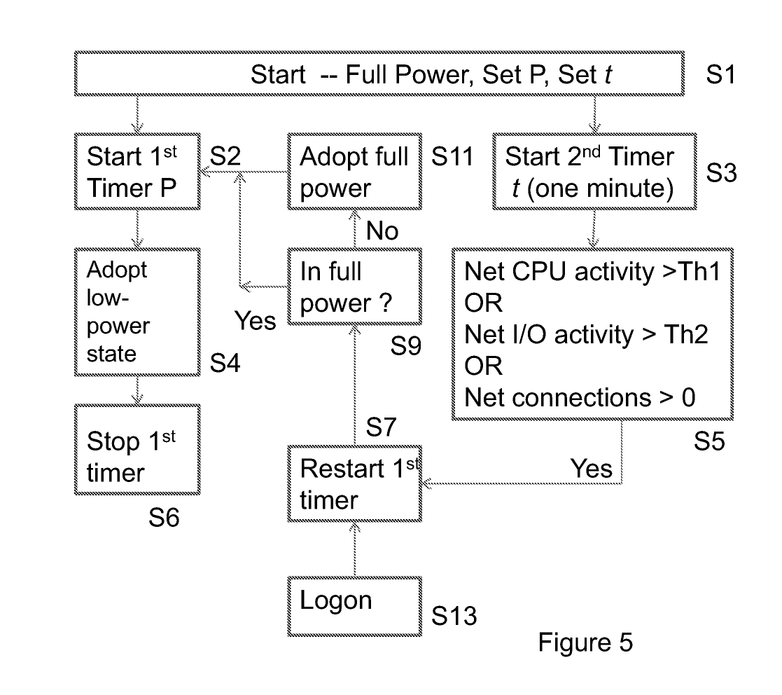

### Overview: FIG. 5

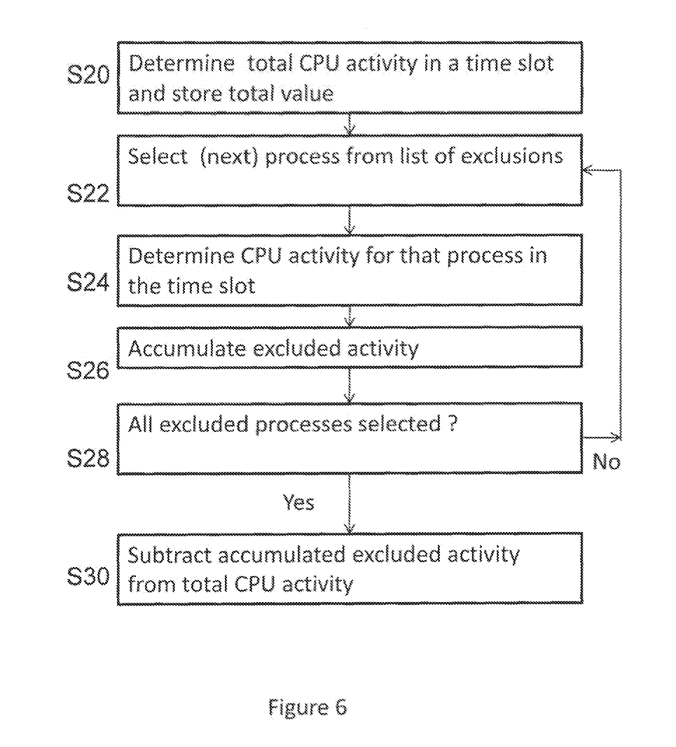

The illustrative methods use net values of activity. In the method of FIG. 5, the method uses net CPU activity, net I/O data amounts and net number of TCP/IP connections as measures of the performance of a computer. These net values are the total values of those activity metrics minus contributions to those total values from predetermined activities. In one example, those predetermined activities are activities which are considered to not contribute directly to the main purpose of the computer and are referred to herein as excluded activities. Measurement of the net values will be discussed in more detail with reference to FIGS. 6 to 8 below.

Referring to FIG. 5, at step S1, a computer operates at full power at start up. First and second timers are started in steps S2 and S3 respectively. The first timer has a selectable first time period P which it measures. That period is a relatively long period of for example 30 minutes or any other suitable period. The period P may be preset by the designer or be selectable by the user in step S1. The second timer measures a shorter time period t of a sampling period or time slot. The time slot may be for example one minute or any other period which is short compared to the period P measured by the first timer. The period t may be preset by the designer or be selectable by the user in step S1.

The method of FIG. 5 determines if there is no net useful activity for period P, e.g. 30 minutes and then causes the computer to adopt a power state referred to herein as a “low power state” which will be described below in more detail. The second timer causes the method to sample the net activity every time slot, e.g. every minute. If in any time slot net useful activity is detected, the first timer is reset. If the computer was in the full power state at reset then it continues in the full power state. If the computer was in the low power state at reset, it is forced into the full power state.

In step S5, in each time slot t the method checks the net values of: CPU activity; I/O data amount; and number of TCP/IP connections. Each net value has an associated threshold value. The net values are compared with the thresholds in step S5.

If any one or more of the net values exceeds its associated threshold, indicating net useful work the first timer is reset in step S7 and step S9 determines if the computer is in the full power state. If it is in the full power state no further action is required and the first timer starts to time its period P at step S2 and the method continues to measure the net values and compare them with the thresholds in the next time slot t. If the computer is in the low power state it is forced S11 into the full power state and the first timer starts to time its period P at step S2 and the method continues to measure the net values and compare them with the thresholds in the next time slot t.

If over the whole period P step S5 does not detect any net useful work then the first timer is not reset and at the end of the period P, in step S4, the computer adopts the low power state and the first timer is stopped. The second timer continues at step S3 and step S5 continues until net useful activity is detected and then the first timer is reset to time period P.

In this example, useful activity is in two categories: the activities sampled in step S5 which are sampled once per minute and thus do not have immediate effect on the power state of the computer; and other activities which immediately cause the computer to adopt the full power state if it was in the low power state as indicated by step S13. In this example there is only one such other activity which is a logon by a user. In alternative embodiments, other events may cause the computer to adopt the high power state or reset the first timer. Such events may be a network event, a process appearing, an activity metric associated with a particular process crossing a threshold value, a service starting or an operating system event occurring. In an embodiment, the user or designer may specify one or more events which cause the computer to adopt the high power state or reset the first timer.

Logon may be included in the activities sampled in step S5. Any of the activities of step S5 may be subject to step S13.

### Determine Net Useful CPU Activity: FIG. 6

Net useful CPU activity is measured as shown in FIG. 6. The measurement of net useful activity is based on a data set, which may be a list, of processes, referred to herein as excluded processes, determined in advance to be non-useful activities. (The production of the data set is described below in the section “Creating Data Sets. . . ”).

In step S20, the total value of CPU activity is determined at the time of a time slot t and the total value is stored. The total value includes for example contributions from all processes running on the computer at the time of measurement plus activity attributable to the kernel of the operating system.

In steps S22 to S28, the contributions to the total value from all the excluded processes running at the time of measurement of the total are determined and subtracted from the total value to produce a net value. In this example that is done by selecting a process in step S22 from a list of excluded processes, determining the activity value attributable to that excluded process in step S24, storing the activity value in an accumulator in step S26 and then at steps S28 and S22 selecting the next process and adding its activity value to the value stored in the accumulator in step S26. Once all the processes have been selected the value accumulated in step S26 is subtracted in step S30 from the total stored in step S20 to give the net value.

It will be appreciated that there are other methods of determining net useful CPU activity. For example the activity values of the excluded processes may be subtracted one at a time from the total value of CPU activity instead of accumulating all the activity levels and then subtracting the accumulated values from the total CPU activity value.

The total activity of the CPU as measured in the time slot t and the activity values of the excluded processes are derived from the operating system in known manner using performance counters.

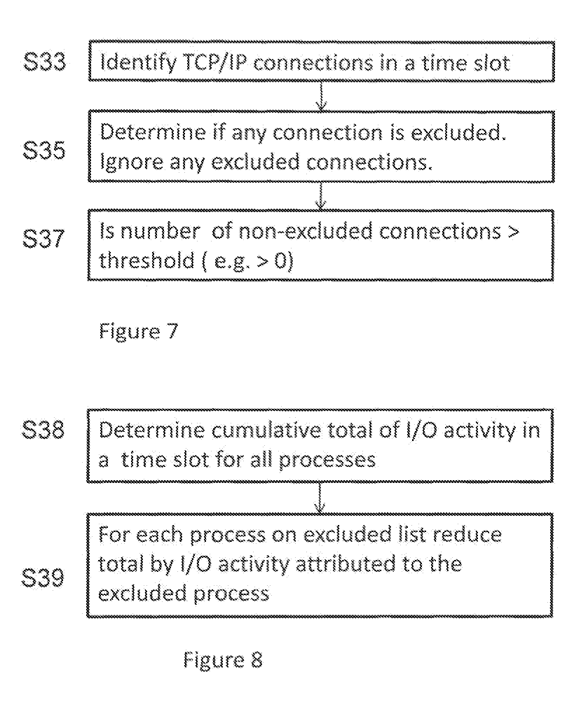

### Determine Net Useful TCP/IP Connections: FIG. 7

Net useful connections are determined as shown in FIG. 7. In the time slot t, the incoming TCP/IP connections are identified in step S33. As with CPU activity there is a list of excluded connections. The excluded connections are identified in step S35 and ignored. Step S37 determines if the number of non-excluded incoming connections exceeds a threshold. In this example the threshold is zero, so if there is a single non-excluded incoming TCP/IP connection, that is sufficient to indicate useful activity. Steps S35 and S37 may be achieved by continuously monitoring incoming TCP/IP connections. Any useful connection, i.e. one not on the excluded list, sets a flag; connections on the list are ignored.

The identification of an incoming TCP/IP connection is achieved using port numbers and processes which are provided by instrumentation data provided by the operating system. Information on how to do this is available from Microsoft Corporation for operating systems supplied by them but the invention is not limited to Microsoft's operating systems. The list of excluded incoming TCP/IP connections is a list of port numbers and processes associated with those port numbers. The following may also be identified and used in the list: source IP addresses of incoming network connections, and other data for example data identifying any connection to a process X, any connection to a port Y or any connection from a source address Z.

In an alternative implementation, in a time slot t, the total number of all incoming TCP/IP connections is determined, the number of those connections on the excluded list is determined and the number of excluded connections is subtracted from the total number of all incoming TCP/IP connections.

### Determine Net Useful I/O Activity: FIG. 8

The measure of I/O activity is the average number of bytes being read and written over the measurement period.

In this example, I/O activity is a single value which is the sum of network I/O, disc I/O and device I/O.

Net useful I/O activity is determined as shown in FIG. 8. In step S38, the total I/O activity is determined at the time of a time slot t and the total value is stored. The total value includes contributions from all processes running on the computer at the time of measurement plus activity attributable to the kernel of the operating system. In step S39, the activity of each excluded process is subtracted from the total activity of step S38 and the net value determined.

Steps S38 and S39 may be implemented as shown in FIG. 6 with I/O activity substituted for CPU activity. The list of excluded processes is the same for both CPU activity and I/O activity in this example, but different lists may be used for CPU activity and I/O activity.

I/O activity associated with the storage of the computer may be monitored separately from network I/O. Also device I/O may be monitored separately. If so, net useful values are determined separately for each type of I/O activity.

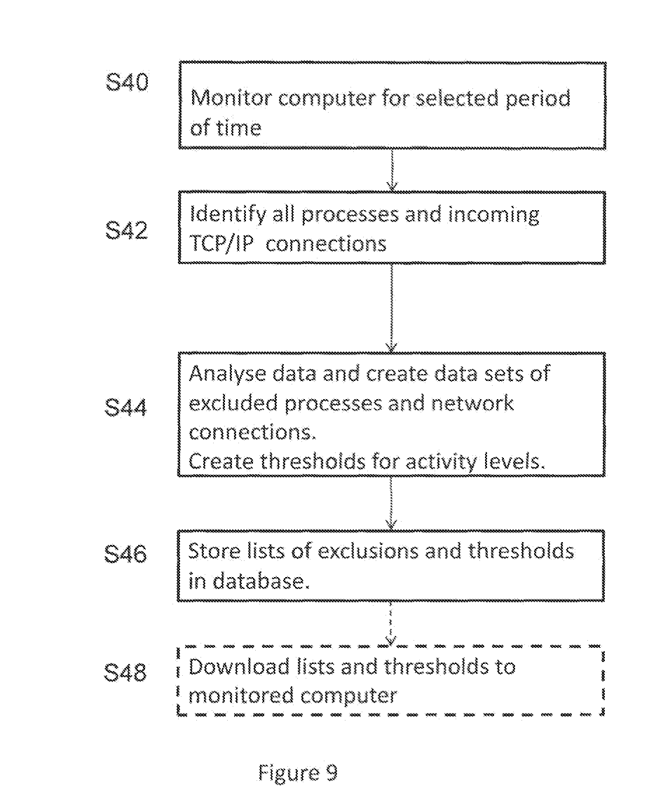

### Creating Data Sets of Excluded Processes and Incoming TCP/IP Connections: FIG. 9

As discussed above the embodiments of the invention use data sets of lists of excluded processes and incoming TCP/IP connections. The data sets may be lists. An excluded incoming TCP/IP connection is identified by the combination of a port number and a process.

To produce the datasets in step S40 of FIG. 9, a computer is monitored for a suitable period of time. The time may be a day, a week, a month or any other time deemed to be suitable. The time should be long enough to be confident that all activity of the monitored computer is monitored. The monitoring is done by an agent on the monitored computer which obtains process names and port numbers from the operating system in known manner as discussed above and transmits the combinations of process names and port numbers to the database of FIG. 1. The agent may also obtain other data for example the source address of an incoming TCP/IP connection.

Step S42 identifies all processes run on the computer over the monitoring period, and all incoming network connections of that period. The names of the processes are stored and the combinations of port numbers and process names identifying network connections are stored.

In step S44, a person, for example a network administrator, analyses the stored process names and names of ports and processes identifying network connection. The person creates a first data set of excluded processes and a second data set of excluded network connections identified by the combinations of process names and port numbers. The person uses their judgment to produce the data sets. The person also uses their judgment to set threshold values for the net useful values. In step S46, the data sets and thresholds are stored in the database of FIG. 1.

In step S48, the data sets and the thresholds are downloaded to the monitored computer for use by the agent on the monitored computer which controls the power of the computer.

### Low Power State

As described above, the computer is in a full power state until no useful activity occurs for a period of time P, when it adopts a low power state.

Examples of low power states include, amongst others:

i) Drowsy (Trade Mark)—The server is set to operate in its lowest power state whilst still fully operational. For example the CPU is controlled to operate in its minimum power state with the clock at its lowest frequency setting, and network cards and other cards of the server are set to their lowest power state and lowest frequency of operation;

ii) Sleep/Standby—The processor is powered down but the system state is preserved as the memory subsystem (RAM) which remains powered;

iii) Hibernate—The processor and RAM are powered down and the system state stored in non-volatile memory, e.g. hard disk; and

iv) Shut down—The Computer is powered down but power may be applied to certain components such that the server can be triggered to wake-up.

### Variants

The above embodiments are to be understood as illustrative examples of the invention. Further embodiments of the invention are envisaged. For example:

The example described above monitors incoming TCP/IP connections. The invention is not limited to TCP/IP but may be applied to other connection oriented communications protocols. The invention is not limited to monitoring incoming connections: it may monitor outgoing connections in addition to or instead of monitoring incoming connections.

The example described above deems any single log-on to be useful activity. The invention is not limited to a single logon: it may require a minimum number of logons greater than one to signify useful work. An embodiment of the invention may use a data set of one or more excluded logons. For example a logon which is not associated with an external service may be deemed to be non-useful activity. For example, a logon to an account that is used only for maintenance tasks may be considered to be a non-useful activity.

The servers 2n of the network of FIG. 1 may all be controlled in the same way with the same data sets of excluded processes and network connections. However, the servers 2n may be controlled using different data sets of excluded processes and network connections. Each server may be separately monitored to create data sets specific to that server. The data sets specific to a server would be stored in the database with an identifier which associates the data sets with the specific server.

Examples of the invention have been described which involve monitoring a plurality of activities, for example CPU activity, I/O activity, network connections and logons. However, the invention may be implemented by monitoring two activities for example CPU activity and I/O activity; or three activities. More than four activities may be monitored. For example a single measure of I/O activity may be replaced by separate measures of network I/O, disc I/O and device I/O.

Whilst the invention has been described by way of example as using programs running on each of the servers 2n to control the servers, the servers may be monitored and controlled remotely.

The embodiments described above sample the total values of one or more activity metrics in each of a succession of time slots. However, an alternative embodiment uses an event monitor instead of time slots and senses the occurrence of an event to initiate sampling of total values and determine the net values.

The invention has been described by way of example with reference to servers, but it may be applied to other computers.

Computer Programs and program carriers.

The invention may be implemented by a program or a set of programs, which when run on a computer or set of computers causes the computer(s) to implement the methods described herein above. In one implementation of the invention:—

program is provided to monitor a server to provide data to the database for the purpose of producing the data sets of excluded activities;

a program is provided on each server 2n to control the power of the server; and

a program is provided on the administrators workstation to enable the administrator to analyse the data received from the monitoring programs on the servers to produce the data set of excluded activities.

The programs may be carried by one or more articles or carriers. A carrier may be a signal, a communications channel, or a computer readable medium. A computer readable medium may be an article for example: a tape: a disc for example a CD or DVD: a hard disc: an electronic memory; or any other suitable non transitory carrier or data storage medium. The electronic memory may be a ROM, a RAM, Flash memory or any other suitable electronic memory device whether volatile or non-volatile.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims. It will be appreciated from the foregoing description that the claims may be combined in combinations other than those specifically recited in the claims.

What we claim is:

1. A computer implemented method of controlling a computer comprising:
periodically determining, as net values, the values of respective ones of a plurality of activity metrics of the controlled computer excluding the contributions to the said values of respective sets of one or more predetermined activities;
comparing the net values with respective threshold values; and
controlling the power state of the computer in dependence on the comparisons.

2. A method according to claim 1, wherein the computer is controllable to adopt a high power state and a low power state, and comprising causing the computer to adopt the low power state if none of the said net values exceed respective threshold values over a predetermined time period.

3. A method according to claim 1, wherein the computer is controllable to adopt a high power state and a low power state, and comprising causing the computer to adopt the high power state if any of the said net values exceeds its associated threshold value.

4. A method according to claim 1, wherein the computer is controllable to adopt a high power state and a low power state, and comprising causing the computer to adopt the high power state in response to a predetermined event.

5. A method according to claim 1, wherein the said one or more predetermined activities are identified by a data set stored in a data store, and the data set is used to determine the activities the contributions of which are excluded.

6. A method according to claim 1, comprising, in respect of a said activity metric, periodically determining the net value thereof by
determining the total value of the activity metric,
determining the contribution(s) to the said total value of one or more predetermined activities, and
subtracting the said contribution(s) from the said total value to provide the net value.

7. A method according to claim 6, wherein the said sets of one or more predetermined activities are identified by a data set stored in a data store, and the data set is used to determine the activities the contributions of which are subtracted from the said total values.

8. A method according to claim 7, comprising determining the net value of another of the said activity metrics by periodically determining the value of at least one activity metric of the monitored computer excluding the contribution to the said value of one or more predetermined activities identified from the said data set. 20

9. A method according to claim 1, wherein a said activity metric is the value of CPU activity and the said predetermined activities are processes.

10. A method according to claim 1, wherein a said activity metric is a value of I/O activity and the said predetermined activities are processes.

11. A method according to claim 1, wherein a said activity metric is the number of active network connections.

12. A method according to claim 1, wherein a said activity metric is the number of logons.

13. A method according to claim 1, wherein, in the low power state, the computer is set to operate in the lowest power state in which it is fully operational.

14. A computer programmed to carry out the method of claim 1.

15. An article comprising a computer readable medium storing a computer program comprising program code which, when run on a suitable computer system, causes the computer system to periodically determine, as net values, the values of respective ones of a plurality of activity metrics of a controlled computer excluding the contributions to the said values of respective sets of one or more predetermined activities;
compare the net values with respective threshold values; and
control the power state of the controlled computer in dependence on the comparisons.

16. An article according to claim 15, wherein the computer readable medium is a tape, disc electronic memory or other non-transitory carrier.

17. A method according to claim 1, further comprising running on the said computer a monitoring program which,
monitors the activity of the computer for a selected period of time,
identifies all activities of the computer over the period of time, and
sends data identifying all the said activities to a remote computer.

18. A method according to claim 1, further comprising receiving, from a monitoring program run on the said computer, data identifying all the said activities of the monitored computer,
analysing the data,
identifying those of the said activities which do not contribute to a predetermined purpose of the computer, and
storing the identifications of the identified activities in a data set.

19. A method according to claim 18, further comprising sending the said data set to the monitored computer.
